(19) United States
(12) Patent Application Publication
(10) Pub. No.: US 2012/0308813 A1
(43) Pub. Date: Dec. 6, 2012

(54) HIGH-TEMPERATURE-RESISTANT HYBRID MATERIAL MADE OF CALCIUM SILICATE AND CARBON

(75) Inventors: Klaus Hoelscher, Bad Lippspringe (DE); Tobias Hoelscher, Paderborn (DE); Wolf Huettner, Hoevelhof (DE); Axel Lengen, Bad Lippspringe (DE); Hans-Juergen Schneider, Oberschoena (DE); Winfried Stellmach, Bad Lippspringe (DE)

(73) Assignee: CALISTHERM VERWALTUNGS GMBH, BAD LIPPSPRINGE (DE)

(21) Appl. No.: 13/522,771

(22) PCT Filed: Jan. 14, 2011
(86) PCT No.: PCT/DE2011/000034

§ 371 Date: Jul. 18, 2012

(30) Foreign Application Priority Data
Jan. 18, 2010 (DE) 10 2010 004 933.6

(51) Int. Cl. C04B 35/16; B32B 5/02; C04B 33/32; B32B 18/00; B29C 39/00; C04B 33/30

(52) U.S. Cl. 428/338; 501/101; 501/100; 264/299; 264/646; 428/221

(57) ABSTRACT

A temperature-resistant ceramic hybrid material has a matrix made of calcium silicate hydrate. Carbon is embedded in the matrix. The carbon is predominantly composed of graphite particles having an ordered graphitic lattice structure and the carbon makes up a weight fraction of up to 40%. The matrix is composed of tobermorite and/or xonotlite and can contain wollastonite rods and/or granular silicate. The size of the graphite particles is 0.01-3 mm. The hybrid material is especially suitable for casting devices for non-ferrous metals.

The invention relates to a high-temperature-resistant ceramic hybrid material having a matrix composed of calcium silicate hydrate in which up to 40% of carbon is embedded.

Such a hybrid material is known from DE 36 11 403 C2. In this, the matrix consists of xonotlite to which wollastonite has been added and of carbon fibers produced from polyacrylonitrile or on the basis of pitch and carbonized in an amount of 0.2-10% by weight. The fiber length is in the range from 3 to 10 mm. In the preferred use of this known material in liquid nonferrous metals, microcracks are formed as a result of thermal shock in the region of contact with the metal melt and these propagate along the carbon fibers into the material. On the positive side, this leads to high fracture energies. On the other hand, the surface is progressively roughened. To smooth and seal the surface, coatings such as boron nitride or graphite slurry are necessary. In the case of casting processes using oil lubrication, e.g. bolt casting, oil penetrates into the open-pored surface of the material and can crack there. Thus, the absorbed and cracked oil is not available for the casting process and has to be continually replenished.

Furthermore, DE 199 28 300 C1 discloses a heat-resistant ceramic material which consists of a calcium silicate hydrate matrix in which a platelet-like material whose main dimensions are 0.5-6 mm has a proportion by weight of 5-30% and is preferably an aluminum-magnesium silicate having a honeycomb texture is embedded. This platelet-like silicate material serves to limit microcracks in the case of temperature changes. The surface of the ceramic material is porous and despite smoothing by machining is rough, so that it has to be smoothed by means of coatings such as boron nitride or graphite slurry, which is time-consuming and costly, when used in liquid nonferrous metal. Here too, a coating with boron nitride or graphite has to be renewed. In both the abovementioned materials, the coatings are rubbed off mechanically. In the case of casting processes which proceed with oil lubrication using the abovementioned materials, the lubricants crack at elevated temperatures; their function is thus no longer present. Compounds such as sulfur and aromatics additionally decompose the microstructure of the material. Cycle times and casting speeds are limited. Downtime occurs in use because emergency running properties are poor or absent. This leads to increased rejects and an additional outlay for technical equipment, personnel, environmental protection and also a significantly increased energy consumption.

Furthermore, DE 691 07 219 T2 discloses a material which is produced essentially from 15 to 40% by weight of lime, from 15 to 40% by weight of a component containing silicon dioxide, from 15 to 50% by weight of wollastonite, from 0 to 15% by weight of inorganic fibers and from 0.5 to 15% by weight of organic fibers with a proportion of from 0.5 to 5% by weight of graphite fibers based on pitch. The base composition of the material comprises calcium silicate hydrate. The graphite fibers based on pitch are fibers which are not only carbonized but are additionally subjected to a heat treatment at 2000° C., which leads to graphitization. The graphite fibers used have a density of 1.63 g/cm³ and a length of 3 mm. This material, too, has the same disadvantages as described above when used in casting molds because of the graphite fibers.

RÖMPP Online, Version 3.6, article on carbon fibers, describes the complicated production process for graphite fibers which are brought into an intermediate form by pretreatment of organic fibers or pitch and converted under protective gas at temperatures of 2000° C.-3000° C. into the high-strength form having a considerable density. This results in their high price.

Furthermore, a material and shaped bodies produced therefrom, in which 21-70% by weight of graphite particles having a size of 7.5 μm are embedded in a calcium silicate matrix, is known from EP 0 166 789 B1. These tiny particles are spherically enclosed in grains having a diameter of 5-150 μm from which the shaped bodies are produced by means of binders. Since the graphite particles are fully encapsulated and irregularly arranged in the material, they do not display a lubricating effect on the surface.

It is an object of the invention to avoid the disadvantages of the previously known ceramic materials and to provide a hybrid material which is impermeable and resistant to lightweight metal melts and their slags and cannot be infiltrated or is infiltrated only slightly by release agents and lubricants such as oils, oil-water suspensions and has high-grade self-lubricating properties.

The carbon particles having a graphitic crystal structure have 10 times the thermal and electrical conductivity than those having a disordered structure. The former significantly homogenize and accelerate the temperature distribution between a hot boundary zone to a metal melt and an external support device or holder and to the environment. In addition, the sheet structure of the carbon crystals allows energy-dissipating sliding relative to the matrix material in the case of differential thermal expansions. This is in advantageous contrast to the behavior of the previously known ceramic platelets or carbonized carbon fibers.

The proportion of carbon particles having an ordered graphitic crystal structure should be at least 60% of the total carbon. The particle dimensions are preferably 0.01-3 mm. In practical experimental operation, a commercial carbon having an average platelet dimension of 0.7 mm and a scatter of dimensions in the range from 0.1 to 1 mm has been found to be useful.

The remaining proportion of carbon has a lower degree of graphitization and disordered graphite crystals. Its structure is less platelet-like but instead tends to be grain-like with smaller dimensions than those of the particles. A carbon content of from 1 to 40% by weight has been found to be useful in experiments, depending on the intended use.

The matrix preferably consists of dendritic xonotlite and/or tobermorite. Up to 65% by weight of wollastonite rods can be added thereto to increase the strength. These wollastonite rods should have an aspect ratio of at least 1:8. The matrix can also contain a particulate silicate material in an amount of not more than 15% by weight to increase the compressive strength. This is, for example, zirconium silicate, lithium-aluminum silicate and/or calcium-magnesium silicate.

The addition of other graphitic carbons such as carbon black in an amount of up to 20% by weight is also advantageous in order to increase the particle density and the thermoelectrical properties.

In the case of uniaxial or biaxial pressing, the graphite particles become aligned with their planes essentially parallel to one another. This makes the hybrid material anisotropic. In terms of the thermal conductivity, this anisotropy makes it possible to control the heat flow in a targeted manner.

In many applications, targeted insulation properties can be set in this way.

In the case of isostatic pressing, an isotropic material having uniform thermal conduction in all spatial directions is formed.

The novel hybrid material has a smooth and impermeable surface and has self-lubricating properties. In use, this leads to a substantial saving of release agents and lubricants and thus to avoidance of production interruptions. The productivity in continuous and pressure casting processes can be increased considerably compared to conventional plant operation. This is a consequence of the improved operating lives or, depending on the casting processes, of the shortened cycle times and results from a targeted setting of the thermal conductivity and improved mechanical stability.

A further decisive advantage of the novel hybrid material results from a four-fold to twenty-fold lower price of the graphite particles compared to carbon fibers.

The properties of the hybrid material can be influenced in a targeted manner to a considerable extent via the relative proportion of the graphite particles. The bulk density of the graphite is, for example, only 0.08 g/cm³. The overall density of the hybrid material decreases as a result from 1.1 g/cm³ at 0% of graphite particles to 1.0 g/cm³ at 16% of graphite particles. Furthermore, the compressive strength increases from 11 to 17 MPa, the fracture energy increases from 5 to 25 Nm, the thermal conductivity increases from 0.35 to 1.65 W/(mK) at 500° C. in the lateral direction and the electrical volume resistance increases from 2.3·10¹³ to 265 ohm·cm, likewise in the lateral direction, in the case of the abovementioned graphite additions.

The hybrid material can be used at up to 1100° C. In an oxidizing atmosphere, the carbon particles newly proposed here begin to oxidize on the surface only at above 500° C.

On the other hand, a carbonized carbon fiber oxidizes at and above 300° C.

In addition, the novel hybrid material has a significantly increased carbon content and the oxidation of the carbon therefore has a significantly lesser negative influence on the properties set.

The good thermal shock resistance also results from the fact that the graphite particles stop incipient crack growth by energy dissipation in the microstructure boundaries of matrix to carbon.

Since the hybrid material can be shaped and worked very well, insulating, nonwetting components for controlling the flow and amount of liquid nonferrous metal alloys and for use in continuous, pressure and mold casting can be advantageously produced therefrom. In addition, it can be advantageously used in shaping processes for glass and plastic and as component in thermal plants and in furnace construction.

Because of the advantageous properties of the novel hybrid material, use in further branches of industry where electromagnetic shielding is also desired is also possible.

In its uses, further advantages are obtained:
self-lubrication, reduction in the consumption of auxiliaries such as release agents, lubricants and oils, which is also environmentally friendly,
an increase in the operating life and emergency running properties of the apparatuses,
process stability in melting apparatuses and melt-conditioning plants and also shaping machines for nonferrous materials, in particular for aluminum and alloys thereof.

The demand for semifinished parts composed of lightweight metal and lightweight metal castings is continually increasing worldwide. The geometries of the components cover a wide variety and for reasons of materials savings, ever thinner-walled components having complex geometries are demanded. This results in increasingly demanding requirements in terms of purity and stability of the properties of the metal melt, which are fully met by the novel hybrid material. The productivity is significantly improved by the use of the novel material.

The hybrid material and shaped parts consisting thereof can, depending on requirements, be produced in various ways by mixing the abovementioned components of the matrix and the graphite particles and optionally the wollastonite rods and/or the particulate silicate and shaping the mixture by dry pressing, filter pressing or casting, in each case to form uncured plates or uncured parts, and then autoclaving and subsequently drying these to form plates or shaped parts.

As an alternative, the matrix material, the xonotlite and/or tobermorite for the matrix, is produced beforehand from a mixture of calcium oxides and/or hydroxides and silicon oxides and/or hydroxides by autoclaving, preferably in a stirring autoclave, and subsequently mixed in pulverulent form and/or as matrix slurry with the graphite and optionally the wollastonite rods and/or the particulate silicate and pressed or cast wet or dry to give plates or shaped parts.

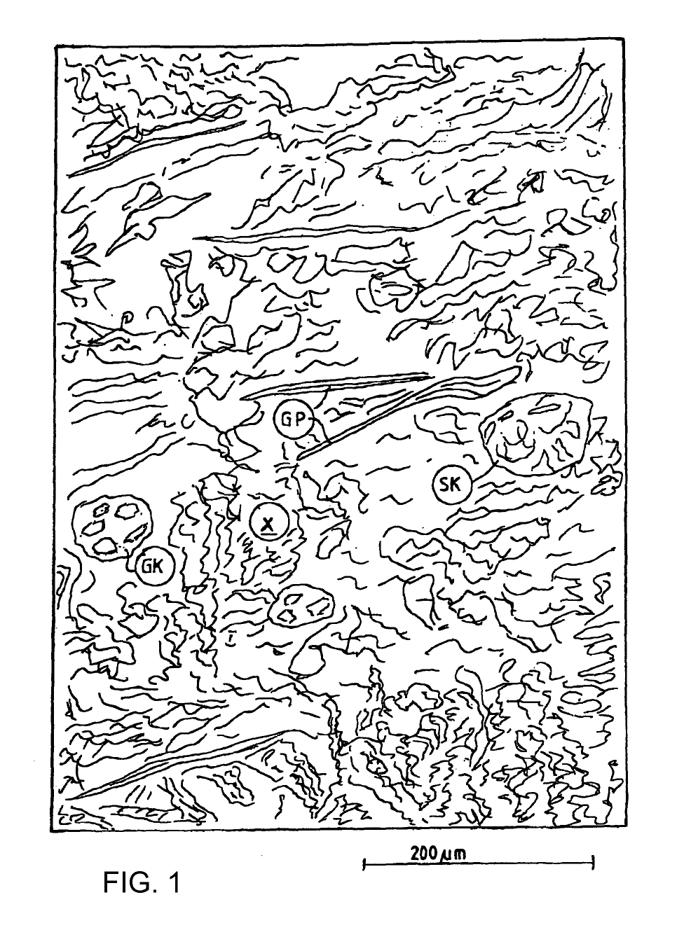

FIG. 1 shows a 100× enlargement of the hybrid material containing 16% by weight of graphite particles.

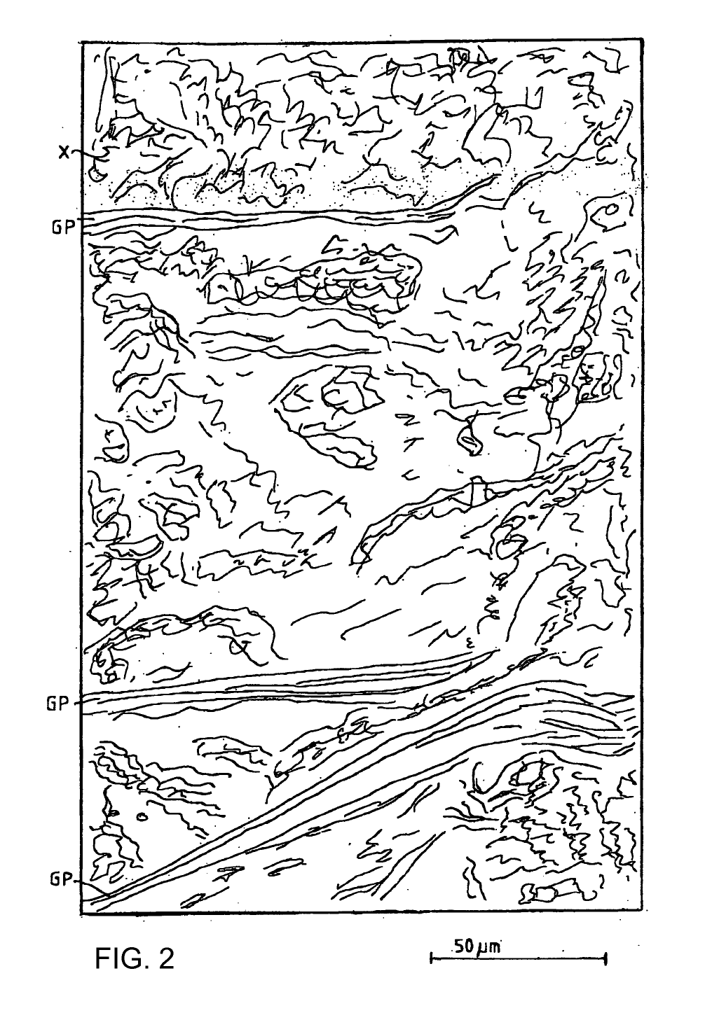

FIG. 2 shows a 3× enlarged section of FIG. 1.

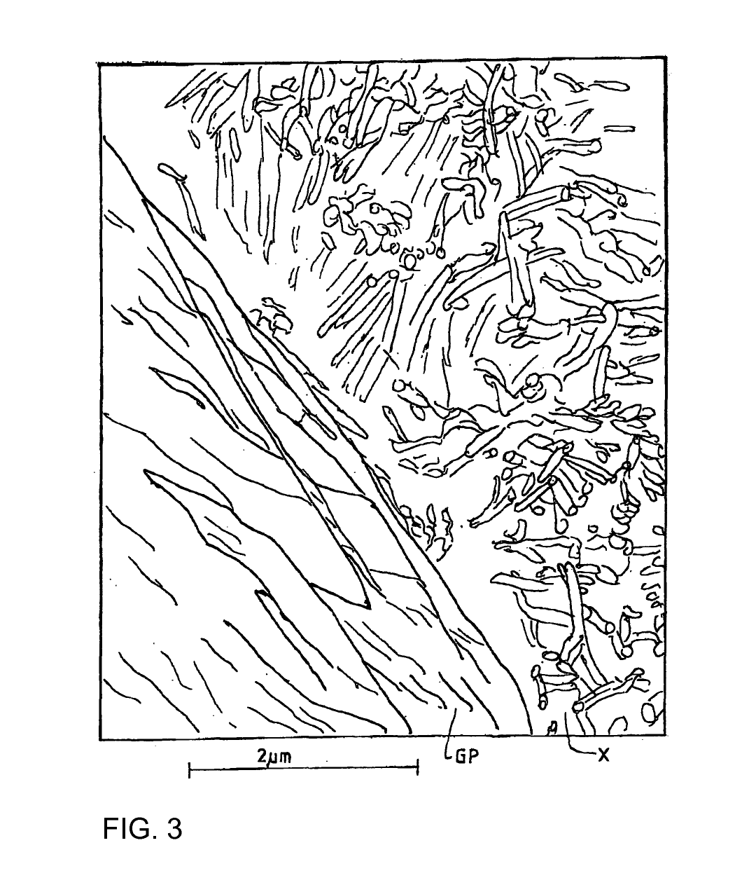

FIG. 3 shows a 10 000× enlargement of a boundary zone between matrix material and a graphite particle.

FIG. 1 shows a coarsely structured matrix composed of dendritic xonotlite X in which essentially parallel graphite particles GP are embedded; the latter can be seen slightly deformed in approximately an end view. In addition, a graphite grain GK and a rounded silicate grain SK are inserted in the matrix. Tiny graphite crystals can be recognized from their blunt-cornered shape on the graphite grain GK.

FIG. 2 shows, by means of a further enlargement, an ordered fine structure in the graphite particles GP. The graphite particles which are layered in a flake-like manner appear in each case as a bundle of lines in the slightly oblique end view.

FIG. 3 shows, highly enlarged, the sheet-like ordered aligned structure on the surface of an exposed graphite particle GP, in front of which, at a distance of about 1 μm, the tiny dendrites of the matrix are present tightly woven together in a disordered manner. The felted dendrites of the xonotlite X are 1-2 μm long and about 0.1 μm thick. The tiny gap between the matrix and the graphite particle GP allows for dissipation of stresses in the microstructure in the case of thermal and mechanical stress.

### LIST OF REFERENCE SYMBOLS

2 GK graphite grain

3 GP graphite particle

4 SK silicate grain

5 X xonotlite

1-10. (canceled)

11. A high-temperature-resistant ceramic hybrid material, comprising:
a matrix of calcium silicate hydrate;
40% by weight of carbon embedded in said matrix of calcium silicate hydrate;
said carbon consisting of more than 60% of graphite particles having a flake-shaped layered, ordered graphitic lattice structure and having an average main dimension of 0.7 mm and a remainder of carbon black-type microcrystalline blunt-cornered graphite grain, said grain having a dimension not greater than said graphite particles and wherein a thermal conductivity is greater than 0.35 W at 500° C.

12. The hybrid material according to claim 11, wherein said graphite particles are oriented with planes thereof parallel to one another, and wherein the hybrid material exhibits an anisotropic thermal conductivity.

13. The hybrid material according to claim 11, wherein said graphite particles have a size dimension of 0.01-3 mm and a bulk density of from 0.05 to 0.5 g/cm³, and said graphite grain has no larger dimension compared thereto.

14. The hybrid material according to claim 11, wherein said matrix is formed of at least one material selected from the group consisting of dendritic xonotlite and tobermorite and contains up to 65% by weight of wollastonite rods.

15. The hybrid material according to claim 11, wherein said matrix contains a further grain-particulate silicate selected from the group consisting of zirconium silicate, lithium-aluminum silicate, and calcium-magnesium silicate in an amount not more than 15% by weight.

16. The hybrid material according to claim 11, formed into a component for controlling a flow behavior of liquid nonferrous metal alloys or a lining for continuous, pressure or mold casting of nonferrous metals, of glasses or plastics or a functional or structural component in furnace and plant construction or a component for electromagnetic shielding.

17. A process for producing the hybrid material according to claim 11, the method which comprises:
mixing components of the matrix and the carbon, and optionally mixing in wollastonite rods and/or particulate silicate, to form a mixture;
shaping the mixture by dry pressing, filter pressing or casting in each case to form uncured plates or parts; and
autoclaving the uncured plates or parts and subsequently drying to form plates or shaped parts of the hybrid material according to claim 11.

18. The process according to claim 17, wherein the mixing step comprises mixing at least one material selected from the group consisting of dendritic xonotlite and tobermorite, and additionally up to 65% by weight of wollastonite rods with the carbon.

19. The process according to claim 17, which comprises subjecting the plates or shaped parts to a heat treatment in situ or in a heat treatment furnace at a given temperature, and thereby providing a reducing atmosphere or reduced pressure at a temperature of above 500° C.-1000° C.

20. A process for producing the hybrid material according to claim 11, the method which comprises:
producing at least one of xonotlite or tobermorite for the matrix from a mixture of calcium oxides and/or hydroxides and silicon oxides and/or hydroxides by autoclaving in an autoclave or a stirring autoclave and then mixing in pulverulent form and/or in a matrix slurry with the carbon, and optionally adding wollastonite rods and/or particulate silicate; and
subsequently pressing or casting wet or dry to form plates or shaped parts of the hybrid material.

21. The process according to claim 20, which comprises subjecting the plates or shaped parts to a heat treatment in situ or in a heat treatment furnace at a given temperature, and thereby providing a reducing atmosphere or reduced pressure at a temperature of above 500° C.-1000° C.
